(19) United States
(12) Patent Application Publication
(10) Pub. No.: US 2023/0299495 A1
(43) Pub. Date: Sep. 21, 2023

(54) PHOTONIC NANOJET ANTENNA USING A SINGLE-MATERIAL DIELECTRIC ELEMENT WITH CIRCULAR SYMMETRY

(71) Applicant: USA as represented by Sec. of the Air Force, Wright-Patterson AFB, OH (US)

(72) Inventors: Soon-Cheol Kong, Centerville, OH (US); George R. Simpson, Saint Paris, OH (US)

(21) Appl. No.: 18/122,055

(22) Filed: Mar. 15, 2023

Related U.S. Application Data
(60) Provisional application No. 63/319,939, filed on Mar. 15, 2022.

(51) Int. Cl. H01Q 15/08; H01Q 19/06

(52) U.S. Cl. CPC H01Q 15/08; H01Q 19/06

(57) ABSTRACT

A photonic nanojet antenna system includes a dielectric element having a circular cross section and formed of a single dielectric material, and at least one feed antenna. The circular cross section of the dielectric element has a diameter such that a photonic nanojet, that is a narrow high-intensity electromagnetic beam, propagates from the dielectric element and into the feed antenna when the dielectric element is illuminated with electromagnetic plane waves. The dielectric element can be, but is not limited to, a sphere, a truncated cylinder, or an ellipsoid.

### CROSS-REFERENCE TO RELATED APPLICATIONS

This application claims the benefit of priority under 35 U.S.C. §119(e) to U.S. Provisional Application Serial No. 63/319,939 entitled “Photonic Nanojet Antennas Using a Single-Material Dielectric Sphere or Cylinder”, filed 15-March-2023, the contents of which are incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to antennas and, more particularly, to dielectric lens antennas.

### BACKGROUND OF THE INVENTION

Non-spherical dielectric lens antennas. FIG. 1A depicts a prior art collimation action of a dielectric lens antenna (n>1) in a receiving mode. FIG. 1B depicts a prior art collimation action of a dielectric lens antenna (n>1) in a transmitting mode. Lens antennas are composed of a dielectric lens and a source/receiving (feed) antenna. Electromagnetic waves go through the collimating action by the dielectric lens in the transmitting mode and incoming plane waves converge to a point in the receiving mode as shown in FIGS. 1A - 1B. In both cases, the source/receiving (feed) antenna needs to be placed at the focal point for efficient operation. Otherwise, ideal collimation cannot be fully utilized. Properly designed dielectric lens antennas can transform divergent energy into plane waves, and thus they can be used for the purpose of high-gain antenna system.

These lens antennas are typically used above 3 GHz for achieving high gain and narrow beam width because weight and dimensions of the lens become very large at lower frequencies. Also, it should be noted that the focal point of a conventional dielectric lens antenna is usually placed wavelengths away from the surface of the lens antenna.

The collimation action of electromagnetic waves by a dielectric lens for the receiving mode shown in FIG. 1A is achieved by ray bending through velocity retardation/acceleration. On the other hand, spherical wave fronts from the source antenna become converted to plane waves after the waves go through the lens as shown in FIG. 1B. There are three different types of lenses in terms of their refractive index (n) of the lens material (n> 1, n < 1 and variable refractive index).

Beam steering can be done for parabolic reflector antennas or ordinary lens antennas. However, in these cases, the parabolic reflector antennas need to be moved mechanically, which requires complexity and costs for operation. Additionally, they have high scanning loss in general. Non-spherical lens antennas also have these same issues.

Luneburg lens antennas. FIG. 2 depicts a prior art Luneburg lens antenna in the transmitting mode. FIG. 3 depicts a prior art commercial Luneburg lens. The illustrated Luneburg lens antenna is a spherical dielectric lens-type antenna, and the refractive index of the Luneburg lens has variable values inside of the lens region. See R. K. Luneburg, United States Patent Number 2,328,157 issued on August 31, 1943, which is hereby incorporated in its entirety by reference. The refractive index of the Luneburg lens is given by:

$$n \left(r\right) = \sqrt{{ε}_{\left(r\right)}} = \sqrt{2 - {\left(\frac{r}{a}\right)}^{2}}$$

where r is the radial distance from the sphere center and a is the sphere radius. It can be seen that the refractive index n decreases radially from the sphere center to the outer surface. The refractive index is √2 at its sphere center and it is unity on the sphere surface.

It is known that the Luneburg lens antenna is an excellent candidate for multi-beam wideband indoor/outdoor communication applications and for airborne radar applications at millimeter frequencies. However, the ideal Luneburg equation is very hard to realize in a fabricated device and as a result a stepped- index configuration is used in practice. FIG. 3 shows a manufactured example that is available from Rozendal Associates, Inc. For more detail see www.rozendalassociates.com. The shell radius is incremented in uniform steps with a different dielectric constant value for each layer.

Another disadvantage of a Luneburg lens antenna is that the lens requires multiple dielectric layers which increases fabrication complexity and cost. Best shown in FIG. 4A. Also, some configurations of Luneburg lenses are more costly than a single-layer dielectric lens.

Dielectric spherical lens antennas. Dielectric spherical lens antennas can be used as a multi-beam scanning antenna with a wide scan angle. There is a known geometrical optics formula for a focal point of a dielectric spherical lens in cases where the sphere diameter is electrically very large. The focal length is expressed as a function of the refractive index of the lens. In general, the sphere diameter of a dielectric spherical lens antenna is electrically very large. However, it is known that collimating properties tend to be mediocre as electrical size increases and it does not exhibit a point focus.

Another disadvantage of dielectric spherical lens antennas is that they have a significant gap between the sphere and the feed antenna as shown in FIG. 4B. With this gap, dielectric spherical lens antennas may require more space and more supporting structures for mechanical stability. Particularly when mounted on moving vehicles and the like.

Accordingly, there is a need for dielectric lens antennas systems having less complexity and/or cost.

### SUMMARY OF THE INVENTION

The present invention overcomes at least one of the foregoing problems and other shortcomings, drawbacks, and challenges of prior dielectric lens antennas. While the disclosed invention will be described in connection with certain embodiments, it will be understood that the disclosed invention is not limited to these embodiments. To the contrary, this disclosed invention includes all alternatives, modifications, and equivalents as may be included within the spirit and scope of the present invention.

According to one embodiment of the disclosed invention a photonic nanojet antenna system comprises a dielectric element having a circular cross section and formed of a single dielectric material, and at least one feed antenna. The circular cross section of the dielectric element has a diameter such that a narrow, high-intensity electromagnetic beam propagates from the dielectric element and into the at least one feed antenna when the dielectric element is illuminated with electromagnetic plane waves.

According to another embodiment of the disclosed invention, a photonic nanojet antenna system comprises a dielectric element having a shape of a sphere and formed of a single dielectric material and at least one feed antenna. The sphere has a diameter such that a narrow, high-intensity electromagnetic beam propagates from the sphere and into the at least one feed antenna when the sphere is illuminated with electromagnetic plane waves.

According to yet another embodiment of the present invention, a photonic nanojet antenna system comprises a dielectric element having a shape of a truncated cylinder and formed of a single dielectric material and at least one feed antenna. The truncated cylinder has a diameter such that a narrow, high-intensity electromagnetic beam propagates from the truncated cone into the at least one feed antenna when the solid truncated cylinder is illuminated with electromagnetic plane waves.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A depicts a prior art collimation action of a dielectric lens antenna (n>1) in the receiving mode.

FIG. 1B depicts a prior art collimation action of a dielectric lens antenna (n>1) in the transmitting mode.

FIG. 2 depicts a prior art Luneburg lens antenna system in the transmitting mode.

FIG. 3 depicts a commercially available Luneburg lens.

FIG. 4A depicts a conventional Luneburg lens antenna system having a lens with multiple different layers.

FIG. 4B depicts a conventional spherical lens antenna system.

FIG. 4C depicts a photonic nanojet antenna system showing a circular cross-section of a photonic nanojet lens according to aspects of the present disclosure.

FIG. 4D depicts a spherical-shaped photonic nanojet lens.

FIG. 4E depicts a cylindrical-shaped photonic nanojet lens.

FIG. 4F depicts an ellipsoidal-shaped photonic nanojet lens.

FIG. 5 is a visualization of the generation of a photonic nanojet by plane wave illumination, depicting the photonic nanojet phenomenon.

FIG. 6A depicts a dielectric sphere antenna system using a photonic nanoj et.

FIG. 6B depicts a fabricated spherical-shaped photonic nanojet lens (diameter = 10 cm).

FIG. 6C depicts a cylindrical-shaped photonic nanojet lens.

FIG. 6D depicts an ellipsoidal-shaped photonic nanojet lens;

FIG. 7 depicts S₁₁ data from an ANSYS HFSS simulation where both the dielectric sphere and feed antenna were included in the simulation.

FIG. 8 depicts gain data from ANSYS HFSS simulations with and without a dielectric sphere.

FIG. 9 depicts a simplified configuration of a 1-D array antenna system with a dielectric sphere and an RF switch system.

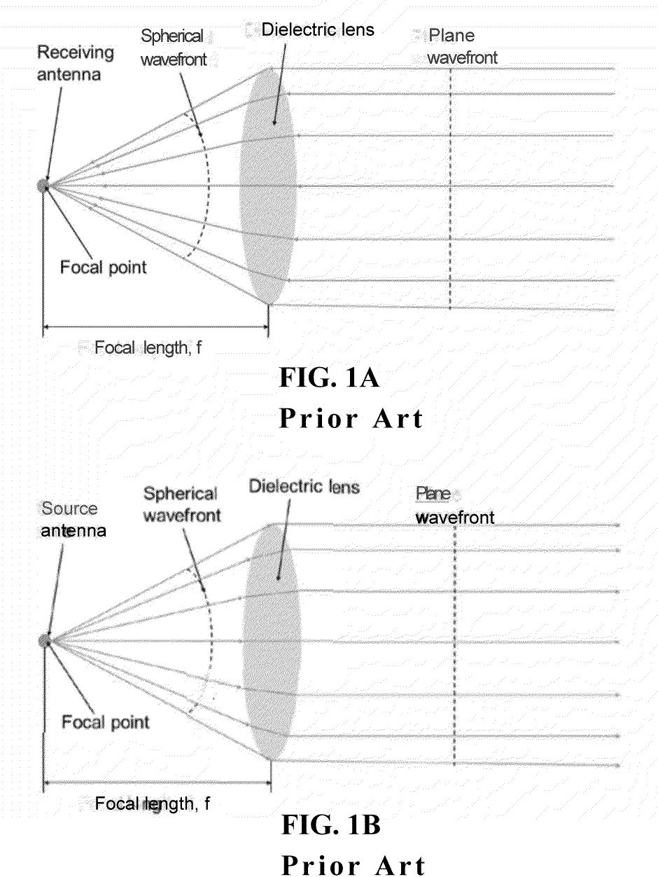

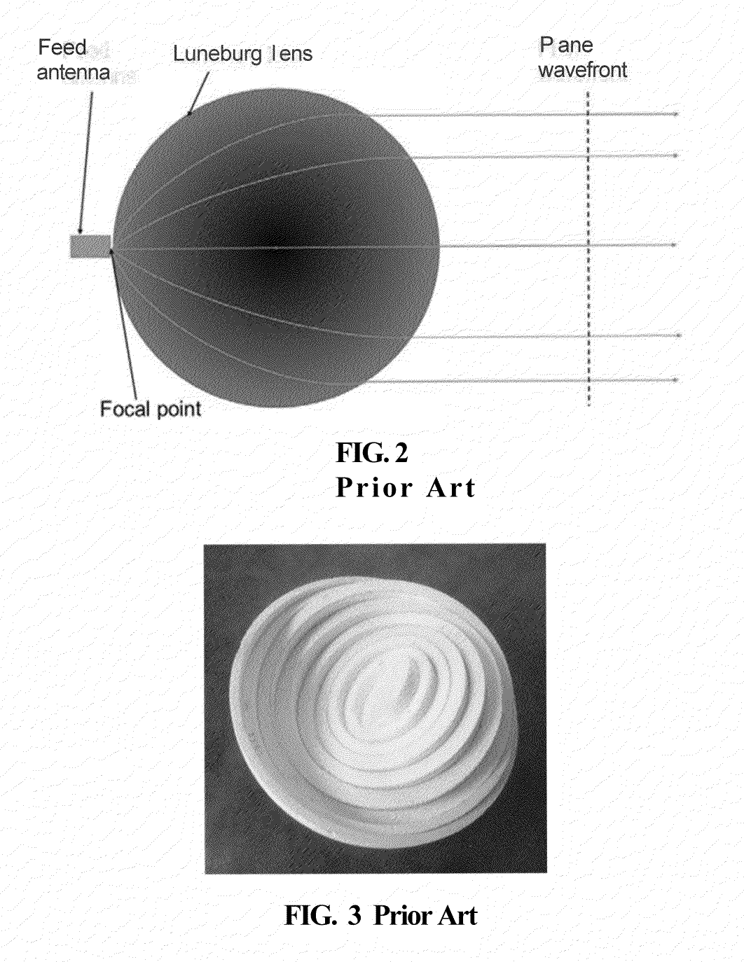

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

This disclosure pertains generally to antenna technology and proposes a novel three-dimensional dielectric lens-type or photonic nanojet antenna system. Prior technologies (systems and methods) similar to the proposed nanojet antenna systems include non-spherical lens antenna systems, Luneburg antenna systems, and spherical lens systems as discussed above. It should be noted that these lens antennas use the lens theory whereas the disclosed inventions use photonic nanojet theory. See A. Heifetz, S. -C. Kong, A. V. Sahakian, A. Taflove, and V. Backman, Journal of Computational and Theoretical Nanoscience. 6, 1979 (2009), the disclosure of which is expressly incorporated herein in its entirety. A dielectric element with circular symmetry, that is a circular cross section, can focus energy in proximity to the dielectric element to form photonic nanojets. Photonic nanojets are narrow intense electromagnetic beams emerging from the “shadow side” surface of a plane wave illuminated dielectric element with a circular cross section (having a diameter greater than the illuminating wavelength) that propagates into the surrounding medium. This is because the electromagnetic waves can be strongly confined in elements with circular symmetry due to total internal reflectance. When incident light is focused on or near a distal surface (with respect to the source) of the dielectric element, a highly localized narrow intense electromagnetic beam is created that is termed a “photonic nanojet” due to its jet-like appearance.

In addition, the lenses of the Luneburg antenna systems use either multiple different dielectric material layers or a complicated dielectric structure. In contrast, the disclosed invention employs only a photonic nanojet lens or dielectric element that has a simple geometric shape and is formed from a single dielectric material.

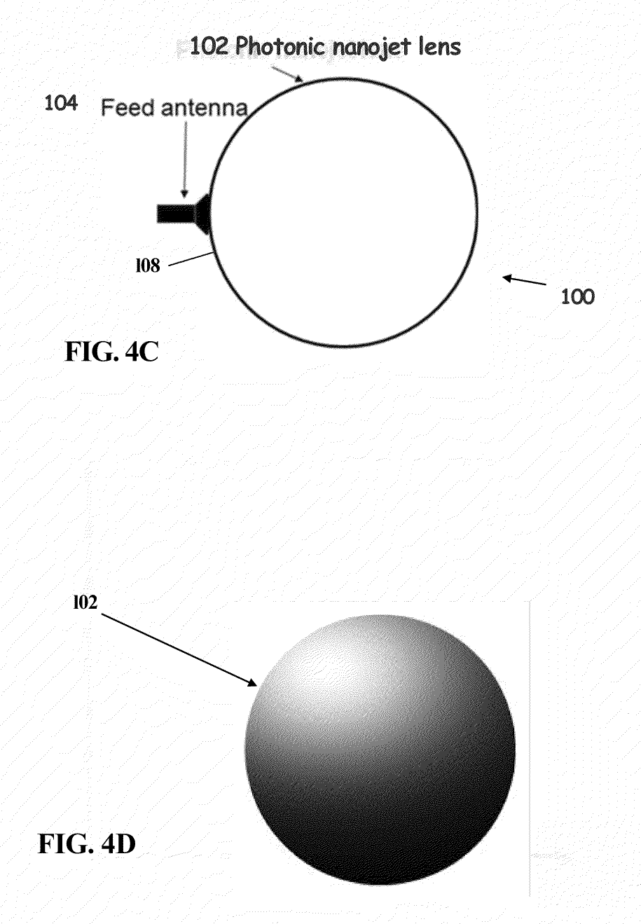

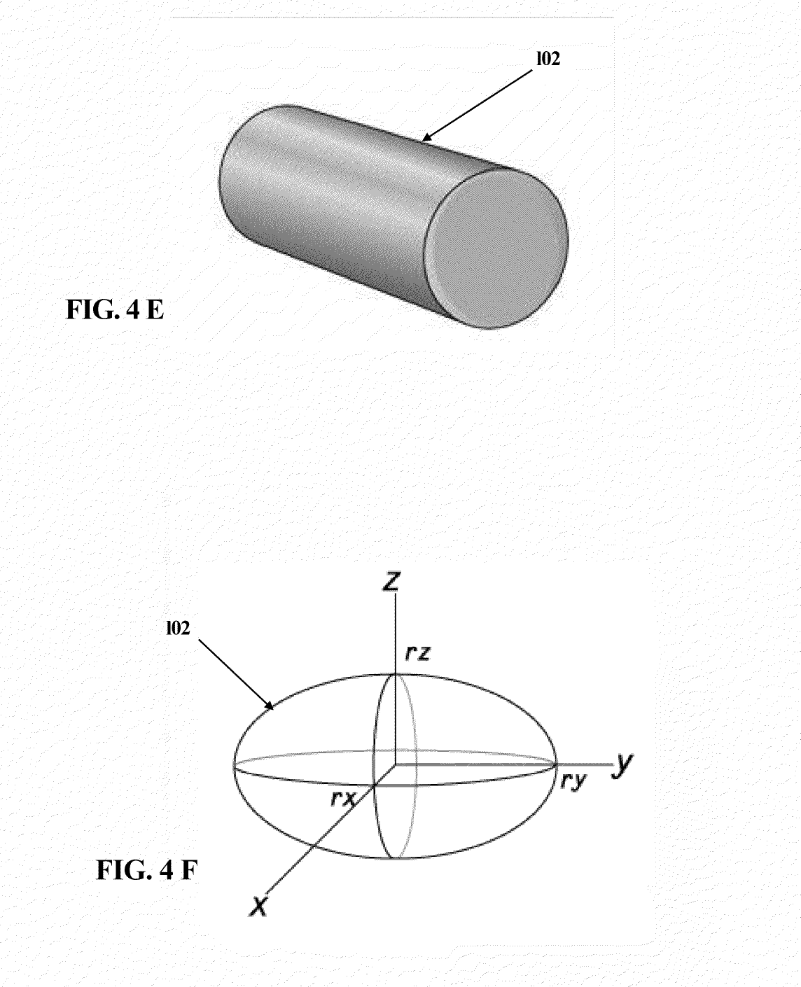

As best shown in FIG. 4C, a photonic nanojet antenna system 100 according to an embodiment of the present invention comprises a photonic nanojet lens or dielectric element 102 having a circular cross section and formed of a single dielectric material, and at least one feed antenna 104. The circular cross section of the dielectric element 102 has a diameter such that a photonic nanojet 106 in the form of a narrow high-intensity electromagnetic beam propagates from the dielectric element 102 and into the at least one feed antenna 104 when the dielectric element 102 is illuminated with electromagnetic plane waves 110 (shown in FIG. 5).

The photonic nanojet lens or dielectric element 102 is preferably a single-material dielectric sphere having a circular cross section through its center (best shown in FIG. 4D), singe-material dielectric cylinder having a circular cross section parallel to its end faces (best shown in FIG. 4E), or single-material dielectric ellipsoid having a circular cross section through its center (best shown in FIG. 4F). However, it is noted that the photonic nanojet lens or dielectric element 102 can have any other suitable shape that can form the photonic nanojet 106. For example, but not limited to, a truncated cone, a disc, and the like. Circle or circular as used herein and in the claims includes true or exact circles as well as near exact circles having manufacturing defects or deformations and/or intended deformations which still enable the photonic nanojet 6 to be formed.

The photonic nanojet lens or dielectric element 102 can be formed of any suitable single material such as, for example, but not limited to Teflon, Polyethylene, Duroid 5880, Duroid 5870, Polystyrene, and the like. The polyethylene is especially very economical. It is noted that any other suitable material can be alternatively utilized.

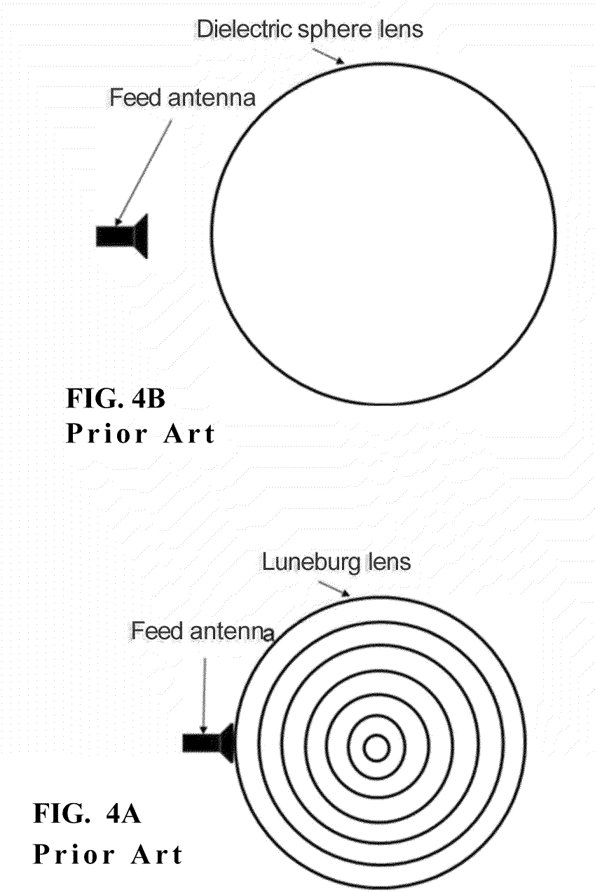

A simple structure is obtained by employing a single dielectric material for the lens. A very low manufacturing cost is expected for the presently disclosed photonic nanojet lenses 102, compared with Luneburg lenses, because a single dielectric material is used whereas Luneburg lenes use multiple layers (best shown in FIG. 3). Small volume and mechanical stability are obtained by using near zero focal length of the photonic nanojet lens or dielectric element 102, compared with a conventional dielectric focusing lenes because there is no gap between the photonic nanojet lens or dielectric element 102 and the at least one feed antenna 104. Extremely high spillover efficiency is obtained by placing the at least one feed antenna 104 at the dielectric surface 108. The disclosed antenna systems 100 have very large scan angles for beam steering if an appropriate array of primary feed antennas 104 is used on the surface of the photonic nanojet lens or dielectric element 102.

FIG. 4C depicts a photonic nanojet antenna system 100 according to aspects of the present disclosure. The desired features of this photonic nanojet antenna system 100 include, for example, but are not limited to: (i) With a single feed antenna 104, the burden of mechanical payload is not required to change the beam direction unlike a parabolic reflector antenna or a conventional non-spherical dielectricfocusing lens antenna, because the transmitting/receiving feed antenna 104 may be mechanically operated separately with the photonic nanojet lens or dielectric element 102 fixed; and (ii) As shown in FIG. 4C, the disclosed configuration is very simple because the photonic nanojet lens or dielectric element 102 material does not use a variable index of refraction like the Luneburg lenses as shown in FIG. 4A or zoning of its surfaces (thus, fabrication cost is much lower than Luneburg lens antennas); and (iii) No gap is provided between the photonic nanojet lens or dielectric element 102 and the single feed antenna 104 unlike conventional spherical lens antenna systems as shown in FIG. 4B.

The above first desired feature (i) is shared by both the conventional non-spherical dielectric focusing lens antennas and the Luneburg lens antennas. The above second desired feature (ii) is shared by the conventional non-spherical dielectric focusing lens antenna. The above third desired feature (iii) is shared by the Luneburg lens antenna. However, it should be noted that only the photonic nanojet antenna 100 disclosed herein exhibits all three of the desired features discussed above.

In FIGS. 4B and 4C, the conventional dielectric sphere lens is distinguished from the photonic nanojet lens or dielectric element 102 because the diameter of the photonic nanojet lens or dielectric element 102 is relatively small in comparison with the focal region being very close to the dielectric sphere surface 108, whereas the focal point of the conventional dielectric sphere lens is largely separated from its surface.

To form the photonic nanojet 106, multiple physical conditions are met including: (1) dielectric permittivity of the photonic nanojet lens or dielectric element 102; (2) the diameter photonic nanojet lens or dielectric element 102; and (3) suitable operating frequencies.

The photonic nanojet lens or dielectric element 102 is preferably configured to form a strong jet-like focal region to enhance antenna gain. That is, physical conditions are configured such that the focal region location is very close to (or at) the shadow-side surface 108 of the photonic nanojet lens or dielectric element 102. Additionally, the at least one feed antenna (or a feed antenna array) 104 is placed on the focal region location mentioned above. Thus, the disclosed photonic nanojet antenna system 100 is well suited for use in applications such as, for example but not limited to, motor vehicular radar, aircraft radar, satellite communications, mobile communications, and the like, by providing no aperture blockage, extremely high spillover efficiency, no scanning loss, wide scanning angle, and no need to move large mass unlike reflector antenna systems. This configuration uses a simple support structure, and accordingly the ultimate objective of a low-cost antenna system is obtained.

In one or more embodiments, the present disclosure provides a photonic nanojet antenna system 100 with at least the following advantages: (i) Simple structure by employing a single dielectric material for the photonic nanoj et lens or dielectric element 102; (ii) Very low manufacture cost, compared with Luneburg lenses; (iii) Small volume and mechanical stability by using near-zero focal length of the photonic nanojet lens or dielectric element 102, compared with a conventional dielectric sphere lenses; and (iv) Extremely high spillover efficiency by locating the at least one feed antenna 104 at the dielectric element surface 108.

The photonic nanojet antenna systems disclosed herein address and provide a design/fabrication method for the antenna systems 100 that provide a wide-angle scanning capability and high-gain property by taking advantage of near-field focusing of the photonic nanojet phenomenon and its reverse event.

Some advantages of this innovation come from the peculiar near field focusing feature under certain physical conditions. It was found by numerical simulations that a narrow, high-intensity electromagnetic beam propagating into the background medium from the shadow-side surface of a plane-wave illuminated dielectric sphere is formed if the illuminating wavelength is larger than the sphere diameter. See X. Li, Z. Chen, A. Taflove, and V. Backman, Optics Express 13, 526, (2005) the disclosure of which is expressly incorporated herein in its entirety by reference. This electromagnetic phenomenon was confirmed experimentally at 30 GHz. See A. Heifetz, K. Huang, A. V. Sahakian, X. Li, A. Taflove, and V. Backman, Applied PhysicsLetters 89, 221118, (2006), the disclosure of which is expressly incorporated herein in its entirety. The focal region, where the maximum field is located, is very close to the sphere surface and this feature allows the proposed antenna s y s t ems to be very unique structurally whereas focal points of conventional dielectric lens antennas or reflector antennas are located far from a transmitting/receiving radiator.

FIG. 5 is a visualization of the generation of the photonic nanojet by plane wave illumination, depicting the photonic nanojet phenomenon. Here, a commercial software CST-Microwave Studio was used to compute the steady-state electric field. The sphere diameter is 10 cm, and the relative permittivity of the sphere (medium 1) was set to 2.69 for a Vero White sphere. A Y-polarized electromagnetic plane wave 110 of frequency = 20 GHz propagates from left to right in the x-axis direction in medium 2 (vacuum). The calculated envelope of the sinusoidal steady-state electric field is visualized in the xy-plane for the sphere of refractive index n₁ = √2.69 embedded within a medium 2 (vacuum) of refractive index n₂ = 1.0. If the refractive index and the sphere diameter are chosen properly, the electric-field peak (the bright spot) emerges from the shadow- side surface of the sphere as a strong j et-like beam, which was named photonic nanojet. In FIG. 5, the brighter the image is, the larger the magnitude of the electric field.

This disclosure leverages the near-field characteristic mentioned above in order to develop a high-gain antenna. Here, shown is an example operating in K-band. A dielectric rod waveguide antenna is used to exploit it for transmitting/receiving electromagnetic wave signals,

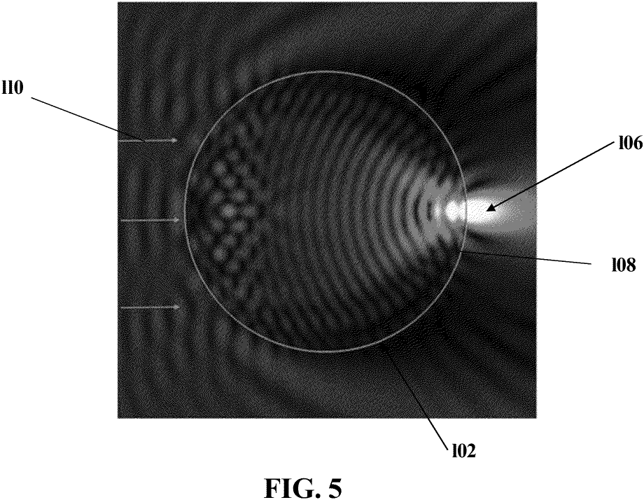

FIG. 6A depicts the disclosed photonic nanojet antenna system 100 using the photonic nanojet with a feed (probe) antenna 104. In order to leverage the photonic nanojet phenomenon, the feed (probe) antenna 104 is placed at the maximum electric-field location, which is very close to the surface 108 or is on the surface 108 depending on the sphere diameter, the sphere refractive index and the operating frequency. Supporting parts holding the sphere antenna are not shown in FIG. 6A, but they will be used in practice.

In the configuration of the photonic nanojet antenna system 100 in FIG. 6A, the feed antenna 104 includes a DRW (dielectric rod waveguide) 112, a DRWA (dielectric rod waveguide antenna) 114, and a DTTM (dielectric taper with top metallization) 116. However, it is noted that any other suitable type of feed antenna 104 can alternatively be used.

FIG. 6B depicts a s fabricated dielectric sphere (diameter = 10 cm). This dielectric sphere was fabricated using a 3-D printer, but any other suitable fabrication method can alternatively be used.

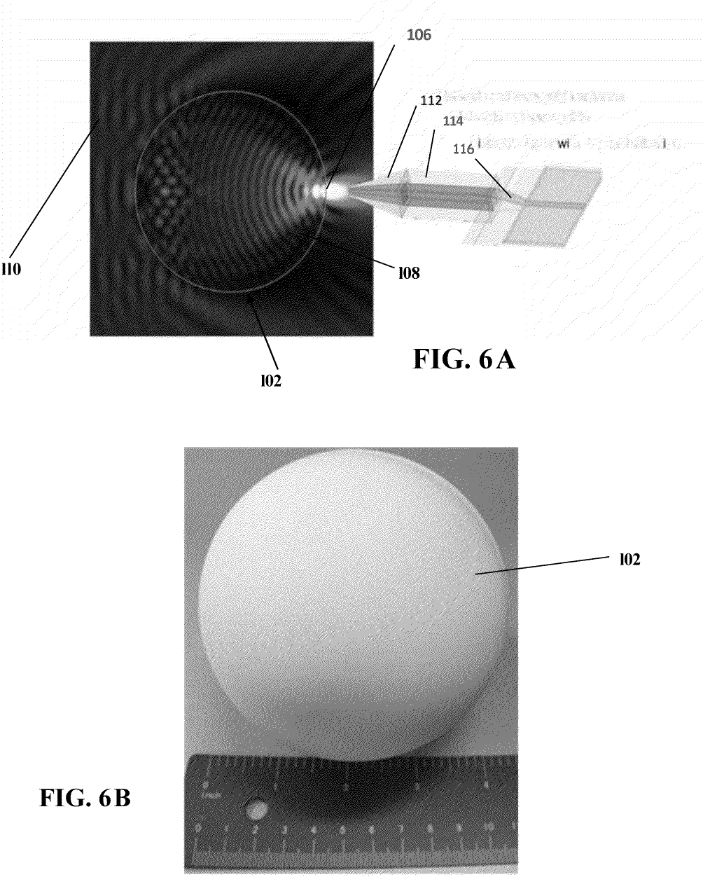

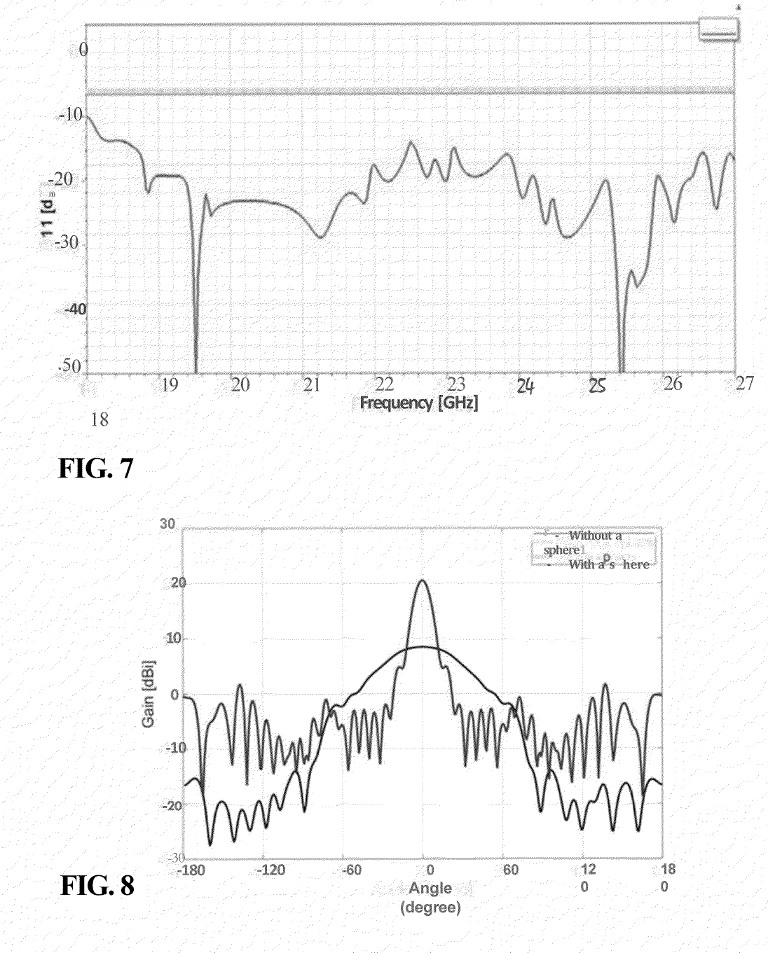

FIG. 7 depicts S₁₁ data from an ANSYS HFSS simulation. Both the sphere and feed antenna were included in the simulation. The ANSYS HFSS (High-Frequency Structure Simulator) simulations were performed to demonstrate properties of the disclosed photonic nanojet antenna 100. The simulation result in FIG. 7 shows that S₁₁ is very good in the whole K band. FIG. 8 depicts gain data from the ANSYS HFSS simulations with and without the sphere. In this case, the dielectric sphere enhances the antenna gain by about 13 dB, compared to without a dielectric sphere.

For the at least one feed antenna 104, a dielectric rod waveguide antenna was used in the antenna systems illustrated FIGS. 6, 7, and 8. However, it is noted that other suitable types of well-designed antennas can alternatively be used as the feed antenna 104 for the same purpose.

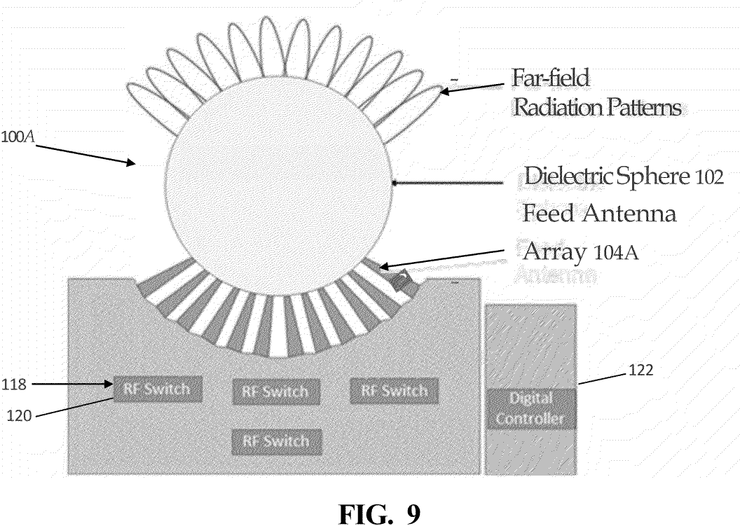

FIG. 9 depicts a simplified configuration of a 1-D array antenna system 100A with a spherical-shaped dielectric element 102, an array of feed antennas 104, and an RF switch system 118. The illustrated RF switch system 118 includes a plurality of RF switches 120 connected to the array of feed antennas 104A and each controlled by a digital controller 122. The proposed system 100A can be used in multiple applications such as, for example but not limited to: (a) Satellite communication antenna systems; (b) Multiple-feed, switched, scanning beam antenna system by using 1-D or 2-D array feed antenna (1-D array antenna system shown in FIG. 9.); and (c) Beam steering/tracking antenna systems.

It is noted that each of the features, structures and/or functions of the various disclosed embodiments can be used in combination with each of the other disclosed embodiments.

From the above disclosure, it should be appreciated that the disclosed antenna systems have less complexity and/or cost than the similar prior art antenna systems discussed above.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical, and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but no other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A photonic nanojet antenna system comprising:
a dielectric element having a circular cross section and formed of a single dielectric material;
at least one feed antenna;
wherein the circular cross section of the dielectric element has a diameter such that a narrow high-intensity electromagnetic beam propagates from the dielectric element and into the at least one feed antenna when the dielectric element is illuminated with electromagnetic plane waves.

2. The photonic nanojet antenna according to claim 1, wherein the dielectric element is one of a sphere, a truncated cylinder, and an ellipsoid.

3. The photonic nanojet antenna according to claim 2, wherein a wavelength of the electromagnetic plane waves is smaller than the diameter of the circular cross-section of the dielectric element.

4. The photonic nanojet antenna according to claim 1, wherein a wavelength of the electromagnetic plane waves is smaller than the diameter of the circular cross-section of the dielectric element.

5. The photonic nanojet antenna according to claim 1, wherein the dielectric element is homogeneous.

6. The photonic nanojet antenna according to claim 1, wherein the at least one feed antenna is located at a focal region of the dielectric element.

7. The photonic nanojet antenna according to claim 6, wherein the focal region of the dielectric element is at or near a surface of the dielectric element.

8. The photonic nanojet antenna according to claim 1, wherein a focal region of the dielectric element is at or near a surface of the of the dielectric element.

9. A photonic nanojet antenna system comprising:
a dielectric element having a shape of a sphere and formed of a single dielectric material;
at least one feed antenna;
wherein the sphere has a diameter such that a narrow high-intensity electromagnetic beam propagates from the sphere and into the at least one feed antenna when the sphere is illuminated with electromagnetic plane waves.

10. The photonic nanojet antenna according to claim 9, wherein a wavelength of the electromagnetic plane waves is smaller than the diameter of the sphere.

11. The photonic nanojet antenna according to claim 9, wherein the sphere is homogeneous.

12. The photonic nanojet antenna according to claim 9, wherein the at least one feed antenna is located at a focal region of the sphere.

13. The photonic nanojet antenna according to claim 12, wherein the focal region of the sphere is at or near a surface of the sphere.

14. The photonic nanojet antenna according to claim 9, wherein a focal region of the sphere is at or near a surface of the sphere.

15. A photonic nanojet antenna system comprising:
a dielectric element having a shape of a truncated cylinder and formed of a single dielectric material;
at least one feed antenna;
wherein the truncated cylinder has a diameter such that a narrow high-intensity electromagnetic beam propagates from the truncated cone into the at least one feed antenna when the solid truncated cylinder is illuminated with electromagnetic plane waves.

16. The photonic nanojet antenna according to claim 15, wherein a wavelength of the electromagnetic plane waves is smaller than the diameter of the truncated cylinder.

17. The photonic nanojet antenna according to claim 15, wherein the truncated cylinder is homogeneous.

18. The photonic nanojet antenna according to claim 15, wherein the at least one feed antenna is located at a focal region of the truncated cylinder.

19. The photonic nanojet antenna according to claim 18, wherein the focal region of the truncated cylinder is at or near a surface of the truncated cylinder.

20. The photonic nanojet antenna according to claim 15, wherein a focal region of the truncated cylinder is at or near a surface of the truncated cylinder.
